(19) United States
(12) Patent Application Publication
(10) Pub. No.: US 2023/0159352 A1
(43) Pub. Date: May 25, 2023

(54) System and Method for Transporting Particulates in Water Using Directional Bubble Walls

(71) Applicant: Kyril Bruce DeFoor, Stevensville, MT (US)

(72) Inventor: Kyril Bruce DeFoor, Stevensville, MT (US)

(21) Appl. No.: 17/993,388

(22) Filed: Nov. 23, 2022

Related U.S. Application Data
(60) Provisional application No. 63/283,102, filed on Nov. 24, 2021.

(51) Int. Cl. C02F 1/24; C02F 1/00

(52) U.S. Cl. CPC C02F 1/24; C02F 1/008; C02F 2103/42

(57) ABSTRACT

A system of directional bubble walls includes a plurality of bubble walls. Each bubble wall may have a shape elongated in one linear direction and have multiple air outlets directed in a perpendicular direction to the elongated direction. The air generated out of air outlets forms a blockade that either blocks particulates in water from moving through it or pushes the particulates away from it. The bubble walls may be placed in parallel to each other and separated from each other by a distance. An air source connected to the bubble walls may sequentially turn on and off the bubble walls such that the water particulates may be removed and pushed in a desired direction. The bubble walls may also be turned on simultaneously, and other modes of operation may be adapted to effectively remove and move water particulates.

### CROSS-REFERENCE TO RELATED APPLICATION

This application claims priority to U.S. Provisional Application No. 63/283,102 filed on Nov. 24, 2021.

### TECHNICAL FIELD

The present description relates generally to a directional bubble system for transporting particulates in water and a method of using such a system. More specifically, the present description relates to a system including a plurality of bubble walls placed in successive order, for example, substantially in parallel and a method of using the system for moving water in order to transport particulates from one area of a body of water to another.

### BACKGROUND

In many ponds, lakes, canals, docks, and beaches, removing duckweeds, algae, oil, debris, trash, and other contaminants or particulates (hereinafter collectively “particulates”) is a difficult and expensive job. These particulates are aesthetically unpleasant, and can cause damage to the environment and the aquatic ecosystem. Duckweeds and algae increase and decrease as the weather changes. Oil spills are mostly man-made and may devastate the water quality. Different kinds of particulates accumulate either near the surface of the water, underwater, or at the bottom floor of the water.

One of the ways to remove water particulates is using bubbles. Bubble plumes generated near the bottom floor of a body of water propel particulates in the water column upward toward the surface. When a substantially linear upstream of bubbles is ejected from the bottom of the water, it can block the drift of the detached particulates from spreading to the opposite side. The bubble “wall,” “curtain,” or “sheet” thus devised has been used to keep particulates away from a shoreline or canal and even contain particulates around a circle of the bubble curtain.

In order to clean a narrow waterway such as a canal, for example, a conventional bubble wall is installed on either side of the bank. When the bubble wall is turned on, they repel contaminants to the center of the waterway. Then the particulates need to be collected to complete the cleaning process. The collecting process is time-consuming and very expensive as well. Moreover, bubble walls often do not work to clean open water because bubble walls operate bidirectionally. When a bubble wall operates in open water, it splits and repels particulates in two directions perpendicular to itself, which does not help in isolating and collecting particulates. Therefore, a better way to clean waste water is needed.

### SUMMARY

The disclosure presented herein relates to a system of directional bubble walls and method of using thereof for transporting particulates in water. More specifically, the present description relates to a system including a plurality of bubble walls and method of using the system for removing and advancing a particulate in water from one area of a body of water to another.

An embodiment of the system of directional bubble walls includes a plurality of bubble walls. Each bubble wall may have a shape elongated in one linear direction and has multiple air outlets directed in a perpendicular direction to the elongated direction. The air generated out of air outlets forms a blockade that either blocks particulates in water from moving through it and/or pushes the particulates away from it. The bubble walls may be placed in parallel to each other and separated from each other by a distance. An air source connected to the bubble walls may sequentially turn on and off the bubble walls such that the particulates may be removed and pushed in a desired direction. The bubble walls may also be turned on simultaneously, and other modes of operation may be adapted to effectively remove and move particulates.

### BRIEF DESCRIPTION OF THE DRAWINGS

Embodiments of the present disclosure are described in detail below with reference to the following drawings. These and other features, aspects, and advantages of the present disclosure will become better understood with regard to the following description, appended claims, and accompanying drawings. The drawings described herein are for illustrative purposes only of selected embodiments and not all possible implementations and are not intended to limit the scope of the present disclosure.

FIG. 1A is a schematic view depicting an embodiment of a directional bubble water particulate treatment system according to an embodiment of the present invention.

FIG. 1B is a partial perspective view depicting the system of FIG. 1A showing a bubble wall in further detail.

FIG. 1C is a sectional view of the bubble wall of FIG. 1B taken at the sectioning plane and in the direction indicated by section lines 1C-1C.

FIG. 2 is a perspective view depicting another embodiment of the directional bubble water particulate treatment system installed near the edge of a shallow body of water.

FIG. 3A is a perspective view depicting another embodiment of the directional bubble water particulate treatment system installed under a canal.

FIG. 3B is a top view of the system of FIG. 3A.

### DETAILED DESCRIPTION

In the Summary above, this Detailed Description, the claims below, and in the accompanying drawings, reference is made to particular features of the invention. It is to be understood that the disclosure of the invention in this specification includes all possible combinations of such particular features. For example, where a particular feature is disclosed in the context of a particular aspect or embodiment of the invention, or a particular claim, that feature can also be used—to the extent possible—in combination with and/or in the context of other particular aspects and embodiments of the invention, and in the invention generally.

The term “comprises” and grammatical equivalents thereof are used herein to mean that other components, ingredients, steps, etc. are optionally present. For example, an article “comprising” (or “which comprises”) components A, B, and C can consist of (i.e., contain only) components A, B, and C, or can contain not only components A, B, and C but also contain one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range including that number (which may be a range having an upper limit or no upper limit, depending on the variable being defined). For example, “at least 1” means 1 or more than 1. The term “at most” followed by a number is used herein to denote the end of a range, including that number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)— (a second number),” this means a range whose limits include both numbers. For example, “25 to 100” means a range whose lower limit is 25, upper limit is 100, and includes both 25 and 100.

As a preface to the detailed description, it should be noted that, as used in this specification, the singular forms “a,” “an,” and “the” include plural referents, unless the context clearly dictates otherwise. Like reference numbers and designations in the various drawings indicate like elements.

The present disclosure relates to a system of directional bubble walls for transporting water particulates and the method of using it. More specifically, the present description relates to a system of a plurality of bubble walls placed in a successive order, for example, substantially in parallel, and a method of using the system for removing and advancing a particulate in water from one area of a body of water to another.

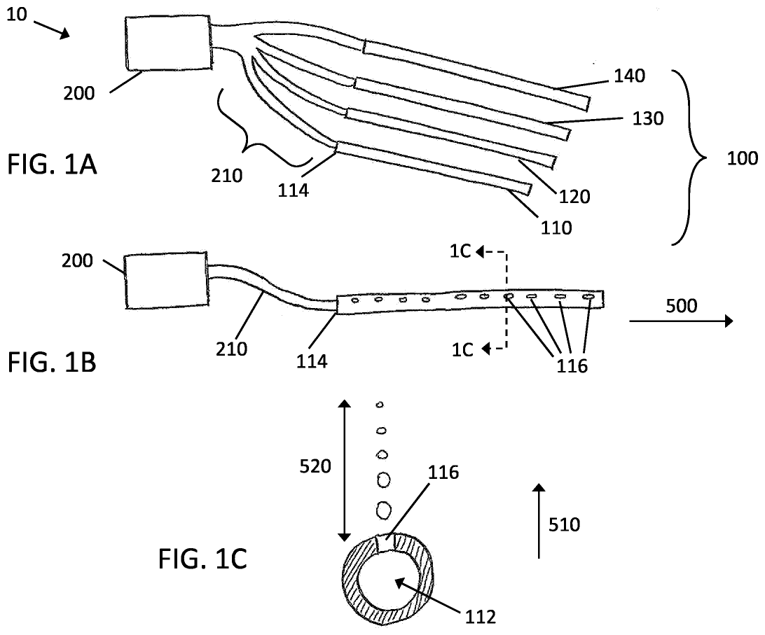

Turning to FIGS. 1A-1C, an embodiment of the directional bubble water particulate treatment system 10 includes a bubble blockade 100 and an air source 200. The bubble blockade 100 includes a plurality of bubble walls, sheets, or curtains. In FIG. 1A, four bubble walls/sheets/curtains 110, 120, 130, 140 are shown as a non-limiting example. Each of the bubble walls 110, 120, 130, 140 may have similar inner structures to each other as described hereinafter. Alternatively, the bubble walls 110, 120, 130, 140 may have different shapes and inner structures to each other. Notably, the bubble walls 110, 120, 130, 140 may have different lengths. Hereinafter, bubble wall 110 will be described in detail as a representative example.

As shown in FIG. 1C, an embodiment of the bubble wall 110 has a hollow area 112 inside it, so that air, oxygen, nitrogen, or any other gas known to a person having ordinary skill in the art may fill the hollow area 112, as further described below. The bubble wall 110 is connected to the air source 200 at an air connection port 114 via a connecting air pipe/hose 210. The connection between the air source 200 and the connecting air pipe/hose 210 at the air connection port 114 may be detachable, such that the air source 200 portion and the bubble walls 110, 120, 130, 140 may be separately stored and maintained when the system 10 is not deployed in the water. Alternatively, the connection between the air source 200 and the connecting air pipe/hose 210 at the air connection port 114 may be permanent and not detachable. The bubble wall 110 also has multiple air outlets 116. The air outlets 116 may be in the form of simple openings. Alternatively, the air outlets 116 may include diffuser heads that are similar to shower heads. The air outlets 116 may take different forms as well known to a person in the art depending on the particulates so that the generated air bubbles may be optimal in removing and/or transporting specific particulates the system 10 targets.

Because the bubble wall 110 may be laid on the bottom floor of the water following the varying contour of the terrain at the bottom, the bubble wall 110 may be made of flexible and pneumatic material capable of containing pressurized gas in the hollow area 112 without leaking. For example, such material may be polyurethane, polyethylene, nylon, any other plastic, stainless steel, rubber with or without braid reinforcement, or any combination thereof.

When the air source 200 injects pressurized gas to the bubble wall 110 via the air connection port 114, the hollow area 112 is pressurized. In a non-limiting embodiment where the bubble wall 110 is made of flexible material, the bubble wall 110 may inflate due to the pressurized gas. The cross-section of the bubble wall 110 in its inflated state may be of circular (as shown in FIG. 1C), elliptical, or any other similar shape allowing the pressurized gas to fill in the hollow area 112. If the bubble wall 110 is non-inflating, the cross-section of the bubble wall 110 may be in any other shape allowing the pressurized gas to fill in the hollow area 112. The cross-sectional area of the hollow area 112 is sufficient to allow for an optimal inside pressure throughout the full length of the bubble wall 110, whose pressure is enough to generate gas bubbles out to the water with sufficient pressure, as described in further detail below.

The bubble wall 110 also has multiple air outlets 116 disposed generally along the elongated direction 500. Each of the air outlets 116 may be separated from each other by, for example, between 3 cm and 1 m. As shown in FIG. 1C, the air outlets 116 are generally directed in a bubble discharge direction 510 perpendicular to the elongated direction 500, such that the bubbles generated out of the air outlets 116 are directed in the bubble discharge direction 510 and form a substantially two-dimensional bubble barrier.

In a non-limiting embodiment (not shown), the air outlets 116 may be generally directed in more than one bubble discharge directions, where each of the bubble discharge directions are angled with respect to one another, such that the bubbles generated out of the air outlets 116 form two or more substantially two-dimensional bubble barriers. For example, the bubble wall 110 may have two sets of air outlets 116, one set of which are directed in a first bubble discharge direction, and the other set of which is directed in a second bubble discharge direction, such that the first bubble discharge direction and the second discharge direction are at 90° of each other. This configuration may be useful when the bubble wall 110 is placed at the bottom floor of the water and used to remove water particulates along the bottom surface of the water and simultaneously form a barrier directed upwards.

The cross-section of each air outlet 116 may be circular, elliptic, square, slit-shaped, or of any other shape of perforation having a diameter or size to allow for the generated pressurized bubbles to sustain their general direction along the bubble discharge direction 510 for a desired distance, or desired barrier height 520, without being dissipated in the water. The desired barrier height 520 is defined as the height up to which strong bubbles are formed enough to remove and/or block water particulates. The desired barrier height 520 may be different depending on the type of water particulates the bubble wall 110 is intended to repel. Accordingly, the effect of the system 10 may vary depending on the type of water particulates. For a non-limiting example, the desired barrier height 520 for a certain type of water particulates may be between 30 cm and 3 m. In order to achieve the desired barrier height and thereby achieve an optimal bubble barrier effect, various parameters including the size and shape of the air outlets 116 and the gas pressure in the hollow area 112 may be adjusted.

The description about the bubble wall 110 is not limited to the specific bubble wall 110, but other bubble curtains 120, 130, 140 or any other bubble walls used in the present invention may have the properties described above.

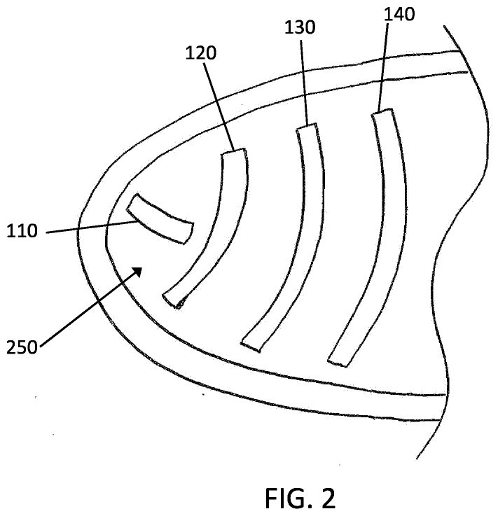

Turning to FIG. 2, an example of the directional bubble water particulate treatment system 10 installed in a shore of a shallow water 250 is shown. The shallow water may be a swimming pool. The system 10 has four bubble walls 110, 120, 130, 140 connected to the air source 200 (not shown). Where the system 10 is not installed in the open water, the connecting air pipes/hoses 210 (as shown in FIG. 1A) between the bubble walls 110, 120, 130, 140 of the bubble blockade 100 and the air source 200 may be buried underground in order to minimize the chance of water waste forming around the connecting air pipes/hoses 210. As with the bubble walls 110, 120, 130, 140, the air pipes/hoses 210 are constructed to withstand pressures as known to a person having ordinary skill in the art sufficient to generate gas bubbles out to the water that can remove and/or block water particulates.

In one embodiment, each of the bubble walls 110, 120, 130, 140 is laid down to the bottom floor of the water by its own weight. Alternatively, an additional weight (not shown) may be attached to the bubble wall 110 so that it may overcome the buoyant force due to the gas in the hollow area 112 and sink under water. The bubble discharge direction 510 may be aligned upwards when the bubble wall 110 is underwater by attaching the additional weight on the opposite side of the bubble discharge direction 510. In another embodiment, each of the bubble walls 110, 120, 130, 140 is affixed to the bottom floor of the water. For example, the bubble wall 110 may be tied to a bottom structure such as a rock or anchored to the bottom with a stake. The bubble wall 110 shown in FIG. 2 is placed at the outermost edge of water 250. Next, the bubble walls 120, 130, 140 are placed one after another. In this non-limiting example, each of the bubble walls 120, 130, 140 is separated from one another by about 3 m. However, any other distances deemed suitable to effectively remove particulates for a person having ordinary skill in the art may be possible.

The air source 200 has a control unit (not shown) that a user may adjust various parameters such as power on/off, time duration, modes of sequential operation, and gas pressure. In a non-limiting example, turning on and off of each bubble wall may be done by operation of one or more solenoid valves, but any other method known to a person having ordinary skill in the art may be used. In some embodiments, a user also can choose different modes of sequential operation. As a non-limiting example, in one mode of sequential operation, the bubble wall 110 is turned on first for about 30 seconds. Then, while keeping the bubble wall 110 on, its adjacent bubble wall 120 is turned on for about 30 seconds. Next, while keeping the bubble walls 110, 120 on, their adjacent bubble wall 130 is turned on for about 30 seconds. Next, while keeping the bubble walls 110, 120, 130 on, their adjacent bubble wall 140 is turned on for about 1 minute. Finally, all the bubble walls 110, 120, 130, 140 are turned off. The mode of operation described above may be repeated several times with the intervals between the operations having varying lengths of time. A non-limiting example of the total length of time may be between a few seconds and a few days. The modes of sequential operation may be programmable within the control unit, for example, by using a microprocessor and a memory.

In another non-limiting example, each of the bubble walls 110, 120, 130, 140 may be sequentially turned on, kept on for 40 seconds, then turned off, while overlapping for 10 seconds with the next bubble wall. For example, 30 seconds after bubble wall 110 is turned on, bubble wall 120 is turned on, then 10 seconds later bubble wall 110 is turned off, and so forth. This sequential operation may be repeated as many times as needed for removing particulates.

In yet another non-limiting example of a mode of operation, all the bubble walls 110, 120, 130, 140 are turned on simultaneously and left on for a certain duration of time, for example for about 5 minutes. Alternatively, the duration of operation for each bubble wall may be up to a few hours.

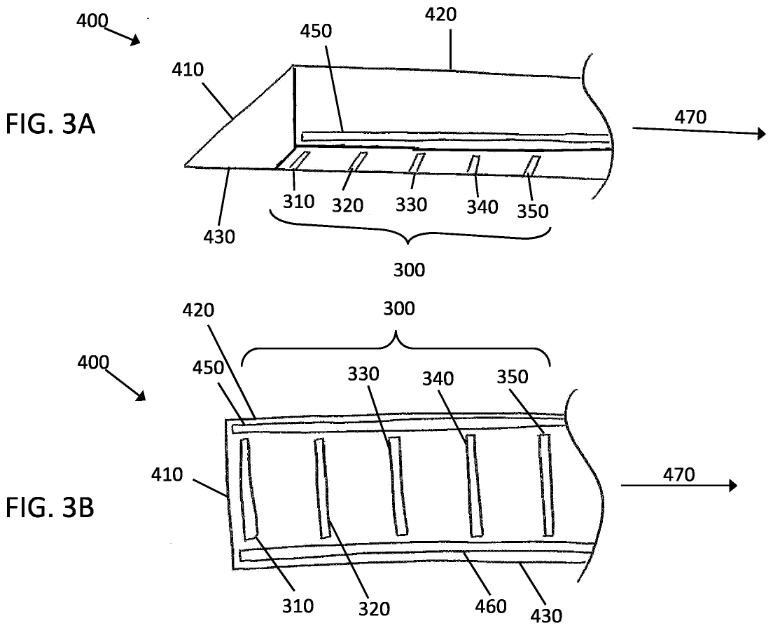

Turning to FIGS. 3A-3B, another non-limiting embodiment of the bubble system is shown. As shown in FIGS. 3A-3B, multiple bubble blockades may be installed in different locations near the shore of the water. For example, in a narrow canal 400 having one end 410 and two banks 420, 430 opposite each other, a pair of bubble walls 450, 460 similar to the bubble wall 110 of FIGS. 1B-1C are installed along the banks 420, 430. Additionally, a bubble blockade 300 similar to the bubble blockade 100 of FIGS. 1A and 2 is installed between the two bubble walls along the banks 420, 430. The bubble blockade 300 is comprised of five bubble walls 310, 320, 330, 340, 350 disposed in parallel to each other, separated by 3 m from each other. In one mode of operation, bubble walls 450, 460 and bubble wall 310 of the bubble blockade 300 are turned on for a certain duration of time. Next, bubble walls 320, 330, 340, 350 are sequentially turned on, in a similar fashion described above for the modes of operation for bubble walls 110, 120, 130, 140. The water particulates are removed and pushed away from the end 410 of the canal 400 toward open water, whose direction is represented generally by open water direction 470.

Alternatively, in another mode of operation, bubble walls 450, 460 and bubble wall 350 of the bubble blockade 300 are turned on for a certain duration of time. Next, bubble walls 340, 330, 320, 310 are sequentially turned on. The water particulates may be removed and pushed toward the end 410 of the canal 400 and later collected by workers.

While embodiments have been illustrated and described, as noted above, many changes can be made without departing from the spirit and scope of the SYSTEM AND METHOD FOR TRANSPORTING PARTICULATES IN WATER USING DIRECTIONAL BUBBLE WALLS. Accordingly, the scope of the SYSTEM AND METHOD FOR TRANSPORTING PARTICULATES IN WATER USING DIRECTIONAL BUBBLE WALLS is not limited by the disclosure of these preferred and alternate embodiments. Instead, the scope of the invention title is determined entirely by reference to the claims. Insofar as the description above and the accompanying drawings (if any) disclose any additional subject matter that is not within the scope of the claims below, the inventions are not dedicated to the public and Applicant hereby reserves the right to file one or more applications to claim such additional inventions.

The reader's attention is directed to all papers and documents which are filed concurrently with this specification and which are open to public inspection with this specification, and the contents of all such papers and documents are incorporated herein by reference.

All the features disclosed in this specification (including any accompanying claims, abstract, and drawings) may be replaced by alternative features serving the same, equivalent, or similar purpose, unless expressly stated otherwise. Thus, unless expressly stated otherwise, each feature disclosed is one example of a generic series of equivalent or similar features.

Any element in a claim that does not explicitly state “means for” performing a specified function, or “step for” performing a specific function is not to be interpreted as a “means” or “step” clause as specified in 35. U.S.C. § 112 ¶ 6. In particular, the use of “step of” in the claims herein is not intended to invoke the provisions of U.S.C. § 112 ¶ 6.

What is claimed is:

1. A method of transporting water particulates using a plurality of bubble walls, the method comprising:
connecting a plurality of bubble walls to one or more air sources, wherein each bubble wall of the plurality of bubble walls comprises an elongated direction, a hollow area formed along the elongated direction, and a plurality of air outlets connected to the hollow area and aligned in a first bubble discharge direction;
placing the plurality of bubble walls under water; and
sequentially operating the plurality of bubble walls.

2. The method of claim 1, wherein sequentially operating the plurality of bubble walls further comprises sequentially controlling air flow to the plurality of bubble walls by controlling the one or more air sources.

3. The method of claim 1, wherein
the plurality of bubble walls comprises a plurality of parallel bubble walls, and
the plurality of parallel bubble walls is substantially parallel to each other, separated from each other by at least a first separation distance in an operation direction.

4. The method of claim 3, wherein sequentially operating the plurality of bubble walls further comprises sequentially operating the plurality of parallel bubble walls.

5. The method of claim 4, wherein the one or more air sources comprises a control unit and control valves for controlling the air flow to the plurality of bubble walls.

6. The method of claim 5, wherein the control unit has one or more modes of sequential operation.

7. The method of claim 6, wherein each mode of the one or more modes of sequential operation comprises a start time, a time duration, and an air pressure for each bubble wall of the plurality of bubble walls.

8. The method of claim 6, wherein the one or more modes of sequential operation are programmable.

9. The method of claim 8, wherein the one or more modes of sequential operation are repeatable.

10. The method of claim 3, wherein sequentially operating the plurality of bubble walls further comprises sequentially turning on the plurality of parallel bubble walls in the operation direction.

11. The method of claim 10, wherein sequentially operating the plurality of bubble walls further comprises sequentially turning off the plurality of parallel bubble walls in the operation direction.

12. The method of claim 11, wherein the sequentially operating the plurality of bubble walls further comprises providing an overlap time interval.

13. The method of claim 2, wherein sequentially operating the plurality of bubble walls further comprises sequentially turning on the plurality of parallel bubble walls opposite to the operation direction.

14. A water particulate transportation system comprising:
a plurality of bubble walls, wherein
each bubble wall of the plurality of bubble walls comprises an elongated direction, a hollow area formed along the elongated direction, and a plurality of air outlets connected to the hollow area and aligned in a first bubble discharge direction; and
one or more air sources connected to the plurality of bubble walls.

15. The water particulate transportation system of claim 14, wherein
the plurality of bubble walls comprises a plurality of parallel bubble walls, and
the plurality of parallel bubble walls is substantially parallel to each other, separated from each other by at least a first separation distance in an operation direction.

16. The water particulate transportation system of claim 15, wherein the one or more air sources comprises a control unit and control valves for controlling air flow to the plurality of bubble walls.

17. The water particulate transportation system of claim 16, wherein the control unit has one or more modes of sequential operation.

18. The water particulate transportation system of claim 17, wherein each mode of the one or more modes of sequential operation comprises a start time, a time duration, and an air pressure for each bubble wall of the plurality of bubble walls.

19. The water particulate transportation system of claim 17, wherein the one of the one or more modes of sequential operation sequentially turns on the plurality of parallel bubble walls in the operation direction.

20. The water particulate transportation system of claim 17, wherein the one of the one or more modes of sequential operation sequentially turns off the plurality of parallel bubble walls opposite to the operation direction.
